(19) United States
(12) Patent Application Publication
(10) Pub. No.: US 2016/0253451 A1
(43) Pub. Date: Sep. 1, 2016

(54) METHOD OF USING A WATER-BASED PHARMACOPHORE

(71) Applicants: KOREA UNIVERSITY, Seoul (KR); RESEARCH FOUNDATION OF THE CITY UNIVERSITY OF NEW YORK, New York, NY (US)

(72) Inventors: Thomas Philip Kurtzman, New York, NY (US); Steven James Ramsey, Bronx, NY (US); Brian Lee Olson, Bronx, NY (US); Eun Sung Cho, Seoul (KR); Sangwon Jung, Seoul (KR); Minsup Kim, Seoul (KR)

(21) Appl. No.: 15/027,397

(22) PCT Filed: Oct. 7, 2014
(86) PCT No.: PCT/US14/59456

§ 371 Date: Apr. 5, 2016

Related U.S. Application Data
(60) Provisional application No. 61/961,181, filed on Oct. 7, 2013.

(51) Int. Cl. G06F 19/16; C40B 30/02

(52) U.S. Cl. CPC G06F 19/16; C40B 30/02

(57) ABSTRACT

A method for producing a template of a binding site of a target protein is provided. A target protein is modeled in silico. A binding site is hydrated with water molecules by finding areas within the binding site where water molecules remain localized during a molecular dynamic simulation. Interactions of the water molecules with the hydration sites are classified as a hydrogen bond acceptor interaction (A) or a hydrogen bond donor interaction (D). The classified interactions are mapped to provide a template of hydrogen bond interactions with the protein.

### CROSS-REFERENCE TO RELATED APPLICATIONS

This application is a non-provisional of U.S. Patent Application Ser. No. 61/961,181 (filed Oct. 7, 2013) the entirety of which is hereby incorporated by reference.

### STATEMENT OF FEDERALLY SPONSORED RESEARCH OR DEVELOPMENT

This invention was made with Government support under grant number 1-SC3-GM095417-01A1 (TK) awarded by the National Institute of Health and grant number 2012043211 (AEC) awarded by the National Institute of Health.

### BACKGROUND OF THE INVENTION

The subject matter disclosed herein relates to in silico modeling techniques for drug screening and, in particular, to such techniques where no lead compound is known.

It is a fundamental tenet of drug design that, in order to potentially bind with high affinity to a target protein, a ligand must be complementary to the target protein surface by donating and accepting hydrogen bonds and making hydrophobic contacts where appropriate. Conventionally, a lead compound is known that functions as a ligand for a particular binding site within a protein. With this ligand in-hand, in silico modeling techniques can be used to study chemical interactions between this ligand and the binding site. Derivatives of the ligand can be intelligently designed to have improved binding with the binding site, thereby providing a derivative with enhanced biological activity, relative to the lead compound. Unfortunately, if a lead compound is not known for a given protein, the options are limited. Improved methods are therefore desired.

The discussion above is merely provided for general background information and is not intended to be used as an aid in determining the scope of the claimed subject matter.

### BRIEF DESCRIPTION OF THE INVENTION

A method for producing a template of a binding site of a target protein is provided. A target protein is modeled in silico. A binding site is hydrated with water molecules by finding areas within the binding site where water molecules remain localized during a molecular dynamic simulation. Interactions of the water molecules with the hydration sites are classified as a hydrogen bond acceptor interaction (A) or a hydrogen bond donor interaction (D). The classified interactions are mapped to provide a template of hydrogen bond interactions with the protein. An advantage that may be realized in the practice of some disclosed embodiments of the method is that binding compounds for a target protein can be identified without requiring a known lead compound.

In a first embodiment, a method for identifying a ligand that binds to a target protein is provided. The method comprises steps of modeling, in silico, a target protein, wherein the target protein comprises a binding site; hydrating, in silico, the binding site with binding molecules that consist of a plurality of water molecules; finding, in silico, hydration sites within the binding site by finding areas where water molecules in the plurality of water molecules remain localized during a molecular dynamic simulation; classifying interactions of the water molecules with the hydration sites as a hydrogen bond acceptor interaction (A) or a hydrogen bond donor interaction (D), mapping the classified interactions to provide a template of hydrogen bond classifications; comparing ligands in a library of ligands to the template; and identifying at least one ligand in the library of ligands as a result of the step of comparing, wherein the at least one ligand satisfies the template within a predefined threshold.

In a second embodiment, a method for producing a template of a binding site of a target protein is provided. The method comprises steps of modeling, in silico, a target protein, wherein the target protein comprises a binding site; hydrating, in silico, the binding site with binding molecules that consist of a plurality of water molecules; finding, in silico, hydration sites within the binding site by finding areas within the binding site where water molecules in the plurality of water molecules remain localized during a molecular dynamic simulation; classifying interactions of the water molecules with the hydration sites as a hydrogen bond acceptor interaction (A) or a hydrogen bond donor interaction (D), mapping the classified interactions to provide a template of hydrogen bond classifications.

In a third embodiment, a program storage device readable by machine, tangibly embodying a program of instructions executable by machine to perform method steps for producing a template of a binding site of a target protein. The method comprising steps of modeling, in silico, a target protein, wherein the target protein comprises a binding site; hydrating, in silico, the binding site with binding molecules that consist of a plurality of water molecules; finding, in silico, hydration sites within the binding site by finding areas where water molecules in the plurality of water molecules remain localized during a molecular dynamic simulation; classifying interactions of the water molecules with the hydration sites as a hydrogen bond acceptor interaction (A) or a hydrogen bond donor interaction (D), mapping the classified interactions to provide a template of hydrogen bond classifications.

This brief description of the invention is intended only to provide an overview of subject matter disclosed herein according to one or more illustrative embodiments, and does not serve as a guide to interpreting the claims or to define or limit the scope of the invention, which is defined only by the appended claims. This brief description is provided to introduce an illustrative selection of concepts in a simplified form that are further described below in the detailed description. This brief description is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

So that the manner in which the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the invention encompasses other equally effective embodiments. The drawings are not necessarily to scale, emphasis generally being placed upon illustrating the features of certain embodiments of the invention. In the drawings, like numerals are used to indicate like parts throughout the various views. Thus, for further understanding of the invention, reference can be made to the following detailed description, read in connection with the drawings in which:

FIG. 1A depicts biotin in the active site of streptavidin while FIG. 1B depicts water in the active site of streptavidin;

FIG. 2 is flow diagram of one method for assigning pharmacophore features to hydration sites;

FIG. 3 is a comparison of the identified hydration sites to the binding sites in a streptavidin-biotin complex; and

FIG. 4 shows four compounds identified by a water-based pharmacophore that were not identified by a ligand-based pharamcophore screen.

### DETAILED DESCRIPTION OF THE INVENTION

The methods described herein assist in the identification of lead compounds. These methods may also assist in the identification of molecular fragments that bind to a given target protein. The methods identify chemical compounds for target protein binding sites in situations where ligand-based pharmacophores are not known or cannot be used. Fragment libraries can subsequently be searched to further identify potential lead compounds. The processes described herein can supplement existing Quantitative Structure-Activity Relationship (QSAR) techniques such that a user can more easily optimize the screened compounds. This assistance can include assigning weights to pharmacophore sites based on local water structural or thermodynamic properties in or proximal to the binding site.

A water-based pharmacophore model for binding to a target protein has been constructed from a solvation analysis of water properties inside the binding site of the target protein. Screening of compound databases against the water-based pharmacophore model identifies strong binders to the targeted protein. In the water-based pharmacophore model, water molecules solvating the target protein are complementary to a surface of the target protein in that the water molecules donate and accept hydrogen bonds where appropriate and make corresponding van der Waals contacts with hydrophobic patches of the surface. In this sense, water on a protein surface mimics the key interactions that a ligand should have in order to bind with high affinity to the targeted protein.

This disclosure provides a method for constructing a water-based pharmacophore that is based solely on information provided from an analysis of computer simulations of the water solvation of a target protein active site. Water-based pharmacophore models can be generated by this method without knowledge of known binders or the ligand-based pharmacophore models built from the known binders. Without wishing to be bound to any particular theory, construction of a pharmacophore is aimed at distilling important features that potential drugs and drug leads should have to bind to a target. The fact that water, when solvating a binding site, has many of these features suggests that a water-based pharmacophore could be constructed based on an analysis of the hydration of an active site alone.

As an initial application of the method, water-based pharmacophores were constructed from data obtained from molecular dynamics simulations of the binding sites of seven target proteins of pharmaceutical importance. To demonstrate the potential utility of the method, enrichment studies were performed on these target proteins by performing screening with the water-based pharmacophore models. In addition, the result of this method were compared to a screening of the same chemical library using conventional docking method with GLIDE™.

### Molecular Dynamic Simulations

Molecular Dynamic (MD) simulations were performed using GROMACS™ 4.6.5 software package with the OPLS-AA force field. The starting structures were solvated in a cubic box of TIP4P water molecules and simulations were carried out in periodic boundary conditions.

Each system was prepared for the productive MD runs as follows: (i) the energy of the system was minimized in two rounds; both used 1500 steps of the steepest descents algorithm followed by the conjugate gradient method for a maximum of 2000 steps. In the first round, all protein atoms were harmonically restrained to their initial positions with a force constant of 1000 KJ/mol⁻¹ nm⁻². In the second round, the system was further relaxed keeping only non-hydrogen protein atoms restrained, with the same force constant. (ii) a solvent equilibration for 100 ps at 300K in the canonical (NVT) ensemble with all protein atoms restrained by a harmonical potential with a force constant of 1000 KJ/mol⁻¹ nm⁻². (iii) an equilibration of the water-density and volume for 100 ps at 300K and 1 atm in the NPT ensemble using a Parrinello-Rahman barostat; (iv) the system was equilibrated for 1 ns at constant volume.

The final MD production run of 10 ns was at constant number of particles, volume, and temperature (NVT), and system configurations were stored every 1 ps, for a total of 10000 stored configurations. The SHAKE algorithm was used to constrain the lengths of all bonds involving hydrogen atoms. Temperature was regulated by Langevin dynamics with a collision frequency of 2.0 ps⁻¹. A 9 Å cutoff was applied to all non-bonded interactions. Particle mesh Ewald was implemented to account for long-range electrostatic interactions, and the Leapfrog algorithm was used to propagate the trajectory. For the constant pressure simulations, isotropic position scaling was implemented with a pressure relaxation time of 0.5 ps.

### Target Proteins Simulation

In this section of this disclosure the details of the molecular dynamics simulations of target proteins are provided. A target protein with a binding site is modeled in silico. To demonstrate proof of principle, the X-ray crystal structures of seven exemplary targets: (1) Acetylcholinesterase (AChE), (2) Androgen receptor (AR), (3) Glutocorticoid receptor (GR), (4) Poly(ADP-ribose) polymerase (PARP), (5) Peroxisome proliferator activated receptor gamma (PPARγ), (6) Progesteron receptor (PR), and (7) Retinoic X receptor alpha (RXRα)—were retrieved from the Protein Data Bank (PDB) and further prepared by PROTEIN PREPARATION WIZARD™ (PPW), which is part of the SCHRÖDINGER® suite. After ensuring chemical accuracy, PPW adds hydrogen and neutralizes side chains that are neither close to the binding cavity nor involved in the formation of salt bridges. Water molecules are removed and hydrogen atoms are added to the structure, at the most likely positions of hydroxyl and thiol hydrogen atoms. Protonation states and tautomers of His residue and Chi “flip” assignment for Asn, Gln and His residue are selected during this step as well. Finally, minimization is performed until the average RMSD of non-hydrogen atoms reaches 0.3 Å.

### Hydration Site Analysis (HSA)

For a preliminary proof-of-concept, and for comparative purposes, ligand-based pharmacophore models were first generated using PHASE™. The binding site is hydrated, in silico, with binding molecules that consist solely of water molecules. Hydration sites within the binding site are found where water molecules remain localized during a molecular dynamic simulation. The ligand-based pharmacophore template comprises a set of sites in three dimensional space, which coincide with various key chemical features of the ligands that bind to the protein. The hydration sites are classified by type, location, and directionality. PHASE™ provides six built-in types of pharmacophore classifications: hydrogen bond acceptor (A), hydrogen bond donor (D), hydrophobic (H), negative ionizable (N), positive ionizable (P), and aromatic ring (R). In one embodiment a water-based pharmacophore-generating method is provided that needs no reference to any pre-existing pharmacophore model. In this manner a template is constructed that can later be compared to a library of known ligands. The template provides a three-dimensional map that permits selection of ligands that satisfy the three-dimensional map of the template within a predetermined tolerance.

Hydration sites in each binding site of each target protein were defined and analyzed thermodynamically based on the MD simulations generated for 10 ns (10,000 frames) as described above. Hydration sites may be determined using a number of methods. In one embodiment, every 10th frame of this segment was used to identify the hydration sites. All instances of water molecules within a predetermined distance (e.g. 5 Å) of any heavy atom of the bound ligand were collected in these 1,000 frames. For each water molecule, the number of neighboring waters from the same set was counted, using the criterion of an oxygen-oxygen distance within a small distance (e.g. 1 Å). With this definition, a water molecule can be counted as its own neighbor if two instances of the water molecule in different frames meet the distance criterion. The location of the first hydration site was then set to the coordinates of the water oxygen with the most neighbors. This water molecule and all of its neighbors were then removed from consideration as potential hydration sites, and the location of the next hydration site was set to the coordinates of the remaining water oxygen with the most neighbors, based on the initial counts. This removal process was iterated until the number of neighbors of all remaining waters was less than twice that expected for a 1,000 frame simulation of bulk water (e.g. less than 280 from 1,000 frames) to identify areas were the density of water is localized (higher than for neat water). For example, for 1000 frames, the number of expected neighbors is about 280 while for 2500 frames the number of expected neighbors is about 800. Each hydration site then was associated with all water instances, from the full 10,000 MD frames, whose oxygen atoms lay within 1 Å of the site. Each hydration site i was associated with mean energy Eᵢ. The energy of a water molecule in a given hydration site was calculated as half the difference between the total energy of the water-protein system with the water present and without it. A script invoking the program GROMACS, with settings matched to those of the MD simulations, was used to compute these energies. The mean energy of the hydration site then is the average of these energies for all water molecules that populate the site, minus the average energy of a water molecule in neat water from matched calculations.

Other methods for finding hydrations sites may also be used. In one embodiment,” placevent” is used which centers hydration sites at high density voxels. Placevent or Chemical Computing Group's MOE software may be used. In another embodiment, three-dimensional gaussians are used to identify hydration sites. In other embodiments, high density water regions or regions of high donation and high acceptance (regardless of density) are correlated to find a hydration site.

### Water-based Pharmacophore Model

In this section of the disclosure the methodology used to construct the water-based pharmacophores is detailed. A water-based pharmacophore model based on screening using streptavidin-biotin complex is provided as an example.

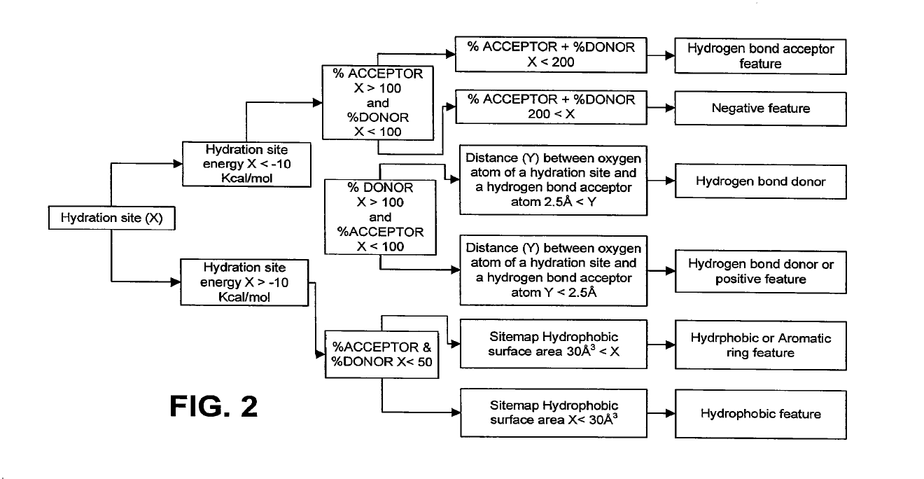

Hydration sites are candidates for pharmacophore features. Subsequent to identification, an appropriate number of the hydration sites are selected and assigned pharmacophore feature types. In one embodiment, a set of criteria is developed for selecting the appropriate number of hydration sites using statistical analysis of interaction of water and protein residues from MD simulations. For each hydration site, the average number of hydrogen bonds which the water molecules at the site form with protein residues was calculated. A % acceptor is defined as the percentage of the total number of hydrogen bond as acceptors and % donor as donors. Both % acceptor and % donor can both be larger than 100 since there can be more than one hydrogen bond of either or both type forming simultaneously at a given hydration site. At each hydration site, solvation energy was calculated. In order to discern hydrophobic and aromatic features SITEMAP™ was used to calculate the volume around a given hydration site. Exemplary criteria for assigning pharmacophore features to these hydration sites are explained by the diagram in FIG. 2. Any hydration sites that do not pass the criteria may be discarded. In these criteria, positive or aromatic features are not determined by themselves alone; rather positive or aromatic features are accompanied by options of hydrogen bond donor or hydrophobic features, respectively. In those cases, more than one pharmacophore model is constructed for a given binding site.

In the exemplary embodiment, the PHASE™ program was again used for the screening of both the water-based and ligand-based pharmacophores. Conformers of the ligands were generated using the CONFGEN™ module. A condition was imposed such that, in order to be considered a match to the pharmacophore, a ligand matches on at least six site points in the water-based pharmacophore model and on at least seven site points in the ligand-based pharmacophore model with the distance matching tolerance set to 1.5 A and other parameters in the default settings so that hits were rejected if their alignment scores were greater than 1.2, their vector scores were less than −1.0, or volume scores were less than 0.0, or any combination thereof. In other embodiments, at least one site point match is the minimum condition. In another embodiment, at least three site point matches are the minimum condition.

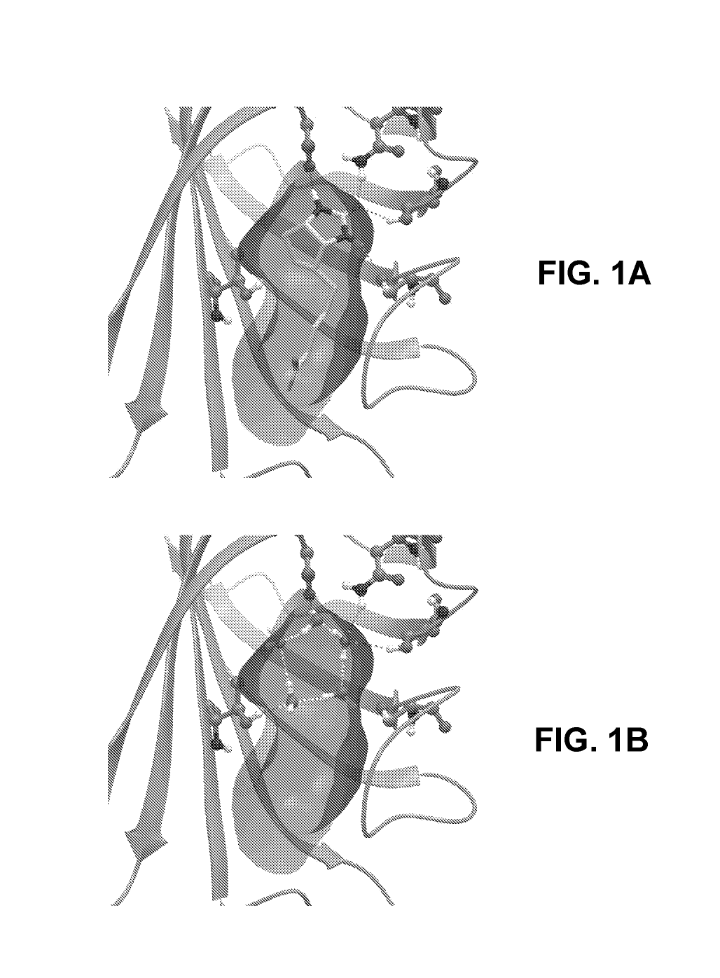

In one exemplary embodiment, the target protein was streptavidin. The screening of the water-based pharmacophore model was compared with screening of a ligand-based pharmacophore model that was constructed from biotin which is known to bind with exceptionally high affinity to streptavidin. FIG. 1A depicts a ligand-based pharmacophore model wherein biotin binds to streptavidin. In comparison, FIG. 1B depicts a water-based pharmacophore model wherein water binds to streptavidin. The water molecules and the ligand make similar contacts to the streptavidin surface.

In the streptavidin proof of principle example, considering the screened compounds from the ligand-based pharmacophore model as true binders, the water-based pharmacophore model achieved significant enrichment. Compounds identified from screening with the water-based pharmacophore model display not only all the hydrophilic interactions that biotin possesses but also additional hydrophilic interactions. Importantly, the water-based pharmacophore model also identified compounds that are structurally similar to the known biotin binders. The water-based pharmacophore model also identified compounds which are predicted to bind with high affinity and that were not identified by the ligand-based pharmacophore model. This suggests that novel chemical space may be explored by the water-based pharmacophore model. In some embodiments, even without experimentally known binders, a water-based pharmacophore model is generated and used for virtual screening.

### Comparison

In this section, results are presented of screening of the water-based pharmacophore against the chemical library, such as the DUD-E decoy compound library. These results were compared to the screening of the same library using a conventional ligand-based docking program, GLIDE™.

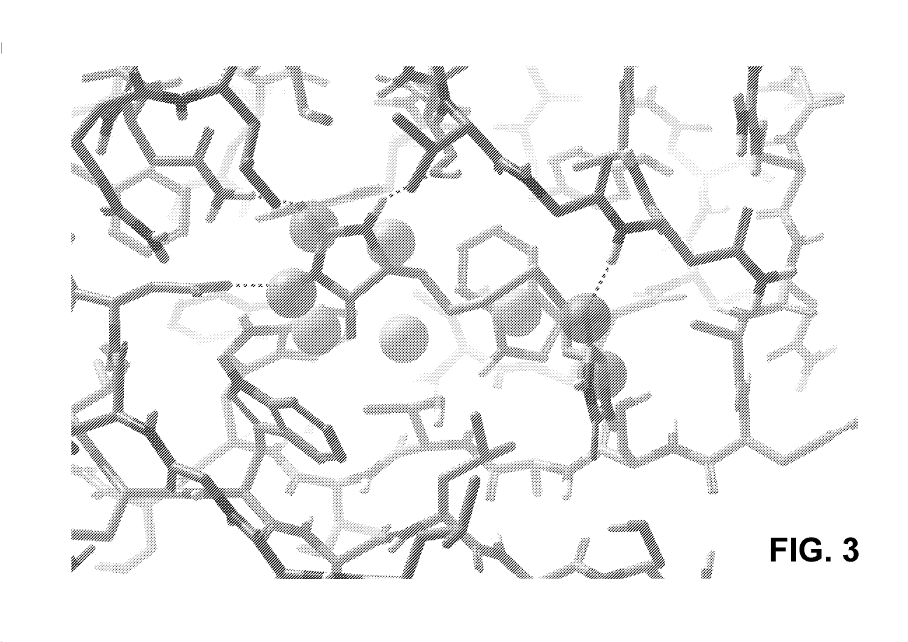

An overlay of the water-based and ligand-based pharmacophores for the biotin-streptavidin example is shown in FIG. 3. Eight high density hydration sites are shown that were generated from the MD simulations of the solvated streptavidin active site and the water-based pharmacophore which resulted from the attribution of a pharmacophore feature (hydrogen bond donating, hydrogen bond accepting or hydrophobic) to each of the hydration sites. The ligand based pharmacophore hypothesis was constructed from the biotin ligand. Visually, the ligand-based and water-based streptavidin pharmacophores are very similar.

For comparison with a screening by docking, the GLIDE™ 5.5 docking program (Schrodinger, Inc.) was used. GLIDE™ is based on grids for energy scoring and ligand matching. One starts with receptor grid generation, in which a grid is generated that conforms to the shape and properties of the receptor. Conformational search in GLIDE™ is done in a hierarchical manner. First, rough matching of ligand atom positions and grid points generates a set of possible ligand poses. These are then refined through successive optimization procedures and scored with GLIDESCORE™ and ranked accordingly.

The effectiveness of the screening method was evaluated by assessing the enrichment of known “actives” within the top-scored compounds, compared to random selection. The enrichment factor is represented by:

$$EF = \frac{{Hits}_{sampled} / {N}_{sampled}}{{Hits}_{total} / {N}_{total}} ,$$

where EF is enrichment factor, Hits_{sampled} is the number of true hits in the hit list, N_{sampled} is the number of compounds in the hit list, Hitsₜₒₜₐₗ is the number of hits in the full data base, Nₜₒₜₐₗ is the number of compounds in the full database. Enrichment factors were calculated for the actives found in the top scoring 1%, 5%, and 10% of the total compounds screened.

Both the water-based and ligand-based pharmacophores were screened against the Enamine library from the Zinc Chemical database. This database contains 2,324,767 compounds that are readily purchasable. Results are summarized in Table 1. There were more screened compounds for the water-based pharmacophore models because the number of site points allowed for screening was one fewer than the ligand-based model. What is notable is that eighty seven of the compounds that were screened by the ligand-based pharmacophore model were also screened by the water-based pharmacophore model - referred to as “overlap” compounds. Sixty five of these overlap compounds were biotin derivatives in that they shared the fused ureido and tetrahydrothiophenes rings and only varied from biotin by the substitution of the valeric acid that stems from the five membered sulfur containing ring. Considering the compounds screened by ligand-based model as true binders, the enrichment factor of the water-based model for streptavidin is 59.3.

TABLE 1
Screening results for streptavidin of water-based and ligand-
based pharmacophore models against the Enamine library
which contains more than 2.2 million compounds. Eight-seven
compounds were found that were identified hits by both
the water-based and ligand-based pharmacophores.

| Pharmacophore | site points | Number | Overlap with biotin model |
|---|---|---|---|
| Water-based | 6 | 4,335 | 87 compounds |
| | | | (65 biotin-derivatives) |
| Ligand-based | 7 | 745 | — |

Similar results were obtained for the example proteins in addition to streptavidin. The disclosed method provided a 16.6 enrichment factor for Androgen Receptor compared to 15.4 for traditional docking methodology. Likewise, the method provided 10.4 enrichment factor for Glucocorticoid compared to 7.8 for docking. The method provided 18 enrichment factor for Progesteron Receptor compared to 7.2 for docking and 18.7 for acetylcholinesterase compared to 14 for docking. In an enrichment study, a number of 10 means that it is ten times as likely to pick a known binding ligand than would be achieved by randomly selecting a ligand from the virtual chemical library.

### Docking Results

In order to view how the screened compounds dock into the streptavidin binding site GLIDE™ SP scored the generated poses with GLIDESCORE™, which gives an approximate binding affinity. GLIDE™ SP was confirmed as being capable of performing with the Streptavidin active site by docking biotin to the site. The root-mean-square-deviation (RMSD) between these two structures is 0.626 which provides evidence that GLIDE™ can successfully predict the binding pose of ligands to streptavidin. GLIDESCORE™ predicted affinity for the streptavidin-biotin complex was −9.225 kcal per mole. While this number is far from the actual affinity (−18.3 kcal/mole) it does predict that streptavidin will bind with good affinity, has all of the appropriate contacts and does not have steric conflicts which would prevent binding.

The eighty seven compounds that were identified in both the water-based pharmacophore screening and the ligand based pharmacophore screening were all computationally docked with GLIDE™ SP to the streptavidin host and the resulting poses were scored via GLIDE™. Of these eighty seven compounds, thirty two were predicted by GLIDESCORE™ to bind with a higher affinity than biotin. All thirty two of these compounds were biotin derivatives of which, ZINC09450170, was predicted to bind with the highest affinity. The ZINC09450170 displays the same hydrogen bond networks as biotin but also has two additional hydrogen bond interactions with the protein.

### Exploring New Chemical Space

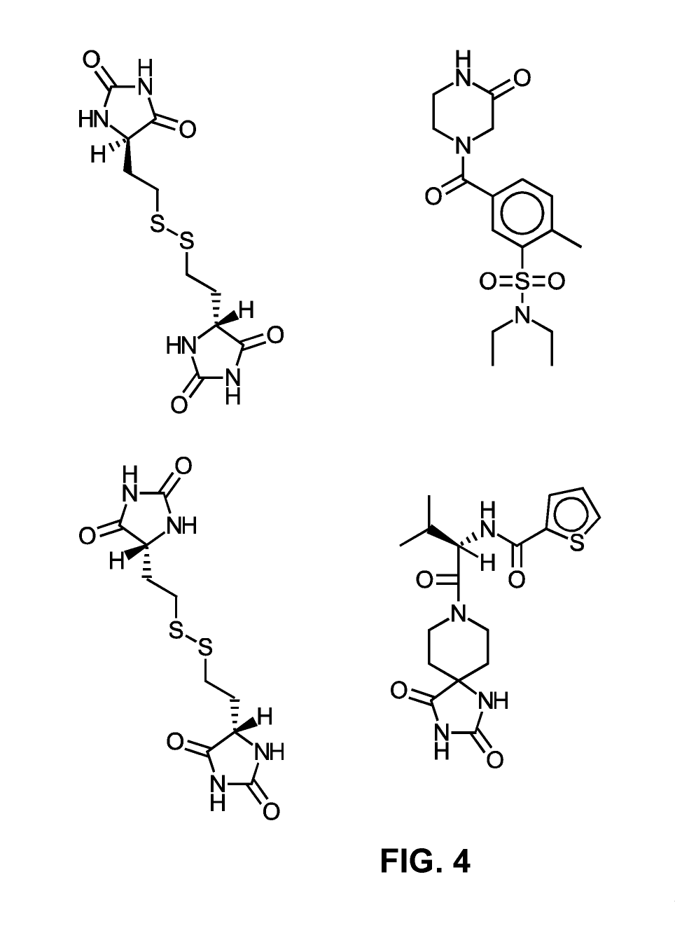

One advantage of the water-based technique would be that it can explore chemical space that is not covered by traditional ligand based approaches. Of the 4,355 compounds that were hits from the water-based pharmacophore, 4248 were not identified by the ligand based pharamcophore screen. All of these compounds were docked and four non-biotin derivatives were identified that were predicted to bind with an affinity greater than that predicted for biotin. These compounds are shown in FIG. 4. Three of these compounds share the carboxy-imidizole ring that makes proximal hydrogen bonds to the surface of streptavidin however they lack the fused ring structure of biotin. The fourth compound has a six membered ring that makes two of these contacts. This is viewed as a success since the water-based pharmacophore explored chemical space unique to the water-based pharmacophore and identified compounds that could potentially bind with high affinity that were not identified by the ligand based screening.

### CONCLUSION

Feasibility of generating pharmacophore models has been demonstrated based purely on the receptor structure through probing the protein binding-site surface with explicit water molecular dynamics simulations. A method to construct the water-based pharmacophore has been introduced and demonstrated that such a pharmacophore is able to explore chemical space that is explored using more traditional ligand-based approaches. The water-based pharmacophore can also be utilized to search novel chemical space that is not covered by the ligand-based approaches and can identify ligands that are not found by ligand-based approaches and have the potential to bind with high affinity. The disclosed method has application both as a stand-alone technology (particularly when binding ligands are unknown) and as a technique for gathering information for incorporation into existing ligand-based pharmacophore construction schemes. The method opens the doors for a number of potentially exciting applications. In particular, we envision that introducing localized solvation thermodynamics through Grid Inhomogeneous Solvation Theory or hydration site approaches such as WaterMap and STOW could help assign weights to individual pharmacophore sites and help improve searching and scoring schemes. Such development could only be implemented using a water-based approach. In one embodiment, one or more of the hydration sites are deleted to produce a new pharmacophore template for subsequent screening against a library of ligands. In another embodiment, additional hydration sites are added to produce a new pharmacophore template for subsequent screening against a library of ligands. In another embodiment, the method further comprises classifying at least one hydrophobic region by identifying at least one aromatic group in the target protein, wherein the template comprises the at least one hydrophobic region. For example, aromatic groups may be classified from clusters of hydrophobic regions, or by combining electrostatic mapping of the binding site, to discern small hydrophobic regions from larger aromatic regions. In one embodiment, aromatic regions are distinguished from hydrophobic regions using SITEMAP™ or other similar techniques.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.), or an embodiment combining software and hardware aspects that may all generally be referred to herein as a “service,” “circuit,” “circuitry,” “module,” and/or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a non-transient computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Program code and/or executable instructions embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer (device), partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method for identifying a ligand that binds to a target protein, the method comprising steps of:
modeling, in silico, a target protein, wherein the target protein comprises a binding site;
hydrating, in silico, the binding site with binding molecules that consist of a plurality of water molecules;
finding, in silico, hydration sites within the binding site by finding areas where water molecules in the plurality of water molecules remain localized during a molecular dynamic simulation;
classifying interactions of the water molecules with the hydration sites as a hydrogen bond acceptor interaction (A) or a hydrogen bond donor interaction (D),
mapping the classified interactions to provide a template of hydrogen bond classifications;
comparing ligands in a library of ligands to the template; and
identifying at least one ligand in the library of ligands as a result of the step of comparing, wherein the at least one ligand satisfies the template within a predefined threshold.

2. The method as recited in claim 1, wherein the step of identifying is deemed to satisfy the template within the predetermined threshold if the at least one ligand binds on at least three site points.

3. The method as recited in claim 1, wherein the step of finding hydration sites finds hydration sites where water density is at least double a density of neat water.

4. The method as recited in claim 1, wherein the step of finding hydration sites finds hydration sites where an oxygen atom of water molecules remain within one angstrom of the hydration site throughout the molecular dynamic simulation.

5. The method as recited in claim 1, wherein the ligand is a peptide.

6. The method as recited in claim 1, wherein the step of classifying interactions classifies the interactions as a hydrogen bond acceptor interaction (A), a hydrogen bond donor interaction (D), hydrophobic (H) or aromatic (R).

7. The method as recited in claim 1, wherein the step of classifying interactions includes classifying directionality of the hydrogen bond acceptor interaction or the hydrogen bond donor interaction.

8. A method for producing a template of a binding site of a target protein, the method comprising steps of:
modeling, in silico, a target protein, wherein the target protein comprises a binding site;
hydrating, in silico, the binding site with binding molecules that consist of a plurality of water molecules;
finding, in silico, hydration sites within the binding site by finding areas within the binding site where water molecules in the plurality of water molecules remain localized during a molecular dynamic simulation;
classifying interactions of the water molecules with the hydration sites as a hydrogen bond acceptor interaction (A) or a hydrogen bond donor interaction (D),
mapping the classified interactions to provide a template of hydrogen bond classifications.

9. The method as recited in claim 8, wherein the step of classifying further identifies hydrophobic regions (H) in the binding site and wherein the template includes the identified hydrophobic regions.

10. The method as recited in claim 8, wherein the step of finding hydration sites finds hydration sites where water density is at least double a density of neat water.

11. The method as recited in claim 8, further comprising a step of synthesizing a ligand that satisfies the template within a predetermined threshold.

12. The method as recited in claim 8, further comprising a step of deleting at least one of the hydration sites to produce a second template for subsequent screening against a library of ligands.

13. The method as recited in claim 8, further comprising a step of adding at least one of the hydration sites to produce a second template for subsequent screening against a library of ligands.

14. The method as recited in claim 8, further comprising a step of classifying at least one hydrophobic region by identifying at least one aromatic group in the target protein, wherein the template comprises the at least one hydrophobic region.

15. The method as recited in claim 8, further comprising a step of classifying at least one hydrophobic region by mapping the electrostatic interactions of the binding site, wherein the template comprises the at least one hydrophobic region.

16. The method as recited in claim 8, wherein the step of finding hydration sites finds hydration sites where an oxygen atom of water molecules remain within one angstrom of the hydration site throughout the molecular dynamic simulation.

17. A program storage device readable by machine, tangibly embodying a program of instructions executable by machine to perform method steps for producing a template of a binding site of a target protein, the method comprising steps of:
modeling, in silico, a target protein, wherein the target protein comprises a binding site;
hydrating, in silico, the binding site with binding molecules that consist of a plurality of water molecules;
finding, in silico, hydration sites within the binding site by finding areas where water molecules in the plurality of water molecules remain localized during a molecular dynamic simulation;
classifying interactions of the water molecules with the hydration sites as a hydrogen bond acceptor interaction (A) or a hydrogen bond donor interaction (D),
mapping the classified interactions to provide a template of hydrogen bond classifications.

18. The program storage device as recited in claim 17, wherein the step of finding hydration sites finds hydration sites where water density is at least double a density of neat water.

19. The program storage device as recited in claim 17, wherein the step of finding hydration sites finds hydration sites where an oxygen atom of water molecules remain within one angstrom of the hydration site throughout the molecular dynamic simulation.

20. The program storage device as recited in claim 17, further comprising steps of:
comparing ligands in a library of ligands to the template; and
identifying at least one ligand in the library of ligands as a result of the step of comparing, wherein the at least one ligand satisfies the template within a predefined threshold.
